(19) United States
(12) Patent Application Publication
(10) Pub. No.: US 2019/0116847 A1
(43) Pub. Date: Apr. 25, 2019

(54) DEVICE TO FACILITATE THAWING OF FROZEN FOOD ITEMS

(71) Applicant: Andrew J. Parker, El Paso, TX (US)

(72) Inventor: Andrew J. Parker, El Paso, TX (US)

(21) Appl. No.: 15/790,030

(22) Filed: Oct. 22, 2017

(51) Int. Cl. A23L 3/36

(52) U.S. Cl. CPC A23L 3/36; A23V 2002/00

(57) ABSTRACT

A device to facilitate thawing frozen food items includes a housing adapted for immersion in a container having a fixed amount of water therein along with full immersion of the one or more frozen food items to be thawed. The housing including a plurality of slits that serve as inlets for the water to be drawn into the housing, a securing structure attached to the housing for securing the device fixedly in place to a surface of the container, and a sealed, waterproof submersible pump provided in the housing, the pump adapted to agitate water from the container that is drawn in by the pump through the slits, The housing further includes an agitator outlet attached to the housing for exhausting the water agitated by the pump into the container so as to be circulated over the one or more frozen food items.

### BACKGROUND

### Field

The example embodiments in general are directed to a device that circulates water around frozen food items or other articles to facilitate thawing thereof.

### Related Art

Freezing is common and important for safe storage and convenient transport of food and other articles. The ability to safely thaw and/or defrost these items is important, particularly for uncooked meat, fish, and similar foods. This is because if these types of food items are thawed or defrosted too rapidly, the taste and texture thereof may be diminished. More importantly, if the temperature during thawing or defrosting of these types of items gets too warm, the risk of microbial growth and food poisoning can be markedly increased.

A food preparer who plans ahead can utilize the safest recommended method, thawing in a refrigerator. But as this takes many hours, typically overnight, thawing via refrigerator is impractical to deploy shortly before cooking. Applying heat or thawing in a microwave oven is not recommended, as the microwave energy and heat negatively affects the color, texture, and taste, and additionally risks raising the temperature of the food items into a range conducive to the growth of harmful bacteria.

Thawing may be safely accelerated by circulating the medium around the frozen food item or other article at a temperature slightly above the freezing temperature of water (32° F.). Conventional devices that circulate heated air for thawing, for example, are well-known in the art. The transfer of heat to a frozen food item or other article is further enhanced by employing a medium which has a greater density and capacity for heat transfer. As such, some conventional devices employ air with elevated humidity and controlled temperature to reduce the thawing time, which often includes some type of air circulation. A widely used, practical method is to immerse the article in running water, in a sink under an open tap. However, this wastes water and occupies the tap; as such a recirculation process may be more desirable.

Example devices employing a circulating water bath for thawing are plentiful in the prior art. Fuller et al. (U.S. Pat. No. 5,146,843) describe a thawing device which fills a container at a predetermined flow rate until it is high enough to drain into a second container, from which it is circulated back into the first container. Halterman et al. (U.S. Pat. No. 5,797,270) describe another chamber with refrigeration means in which the circulated water maintains a specific desired temperature, more specifically a sealable chamber which circulates water around frozen items using an automated “thawing cycle”. Similarly, Thompson (U.S. Pat. No. 6,691,608) describes a thawing device that more simply re-circulates water through two containers. Luketic et al. (US Patent Appl. Publ. US 2013/0323386) describe a commercial sink with an integrated water circulator.

These above-described conventional devices are expensive and large, making them practical only in commercial preparation areas that require regular, continuous operation. Also, many of the conventional devices have a fixed capacity to handle frozen articles, which may be insufficient for preparing a large meal. Else, these devices are too cumbersome or large when it is desired to conveniently thaw a few small food articles, and typically are extremely wasteful as to power consumption and water usage. Additionally, these conventional devices often incorporate one or more containers, which increases the difficulty to clean and sterilize if they should become contaminated.

Accordingly, what is needed is a device that circulates water around frozen food items or other articles to facilitate thawing thereof that is simple to use, compact in size, and portable so as to be easily adapted for placement into a kitchen sink, bowl or container with the frozen item therein to defrost the item within the sink, container within the sink, or within a container on a kitchen counter or other surface. Additionally, there is desired a device that is placed in a fixed amount of water within a container so as to circulate that water around frozen food items, thereby conserving water usage.

### SUMMARY

An example embodiment of the present invention is directed to a device to facilitate thawing of one or more frozen food items, which includes a housing adapted for immersion in a container having a fixed amount of water therein along with full immersion of the one or more frozen food items to be thawed in the water, the housing including a plurality of slits in adjacent spaced relation to one another and serving as inlets for the water to be drawn into the housing, and includes a securing structure attached to the housing for securing the device fixedly in place to a surface of the container. The device further includes a sealed, waterproof submersible pump provided in the housing, the pump adapted to agitate water from the container that is drawn in by the pump through the slits, and an agitator outlet attached to the housing for exhausting the water agitated by the pump into the container so as to be circulated at a constant flow rate over the one or more frozen food items.

Another example embodiment is directed to a device to facilitate thawing of one or more frozen food items, which includes a housing adapted for immersion in a container having a fixed amount of water therein along with immersion of the one or more frozen food items to be thawed in the water, the housing including a plurality of slits therein for ingress of the water into the housing, and includes one or more suctions cups attached to an external surface of the housing body for securing the device fixedly in place to a surface of the container. The device further includes a sealed, waterproof submersible pump provided in the housing body and adapted to agitate water from the container that is drawn up through the slits, and an agitator outlet in the housing for exhausting the water agitated by the pump into the container so as to be circulated at a constant flow rate over the one or more frozen food items.

Another example embodiment is directed to device to facilitate thawing of one or more frozen food items, which includes a housing adapted for immersion in a container having a fixed amount of water therein along with immersion of the one or more frozen food items to be thawed in the water, whereby a lower portion of the housing has a plurality of slits in adjacent spaced relation. The device includes a securing structure attached to the housing, the securing structure adapted to fix the device in place to a surface of the container and simultaneously to plug a drain of the container to permit filling with water, a sealed, waterproof submersible pump provided in the housing to agitate water from the container that is drawn through the slits, and includes an agitator outlet in the housing body for exhausting the water agitated by the pump into the container so as to be circulated at a constant flow rate over the one or more frozen food items.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limitative of the example embodiments herein.

FIG. 1 shows a perspective view of a device to facilitate thawing of frozen food items, according to an example embodiment.

FIG. 2 shows a bottom perspective view of the device of FIG. 1.

FIG. 3 shows a top perspective view of the device of FIG. 1.

FIG. 4 shows an exploded parts view of the device of FIG. 1.

FIG. 5 shows a top plan view of the device of FIG. 1 immersed with a sealed food item in a container.

FIG. 6 shows a rear plan view of the container of FIG. 5 with food item and device therein.

FIG. 7 shows a perspective view of a device to facilitate thawing of frozen food items, according to another example embodiment.

FIG. 8 shows a bottom perspective view of the device of FIG. 7.

FIG. 9 shows an exploded parts view of the device of FIG. 7.

FIG. 10 shows a top plan view of the device of FIG. 7 immersed with a sealed food item in a container.

FIG. 11 shows a rear plan view of the container of FIG. 10 with food item and device therein.

FIG. 12 shows a partial exploded parts view to facilitate thawing of frozen food items, according to another example embodiment.

FIG. 13 shows a top plan view of the device of FIG. 12 immersed with a sealed food item in a container.

FIG. 14 shows a rear plan view of the container of FIG. 13 with food item and device therein.

FIG. 15 shows a perspective view to facilitate thawing of frozen food items, according to another example embodiment.

FIG. 16 shows a top plan view of the device of FIG. 15 immersed with a sealed food item in a container.

FIG. 17 shows a rear plan view of the container of FIG. 16 with food item and device therein.

### DETAILED DESCRIPTION

As to be described in detail hereafter, the example embodiments introduce a device to facilitate thawing of frozen food items which is compact in size for ease of use and storage, which is readily usable with various quantities of frozen food items or articles having various dimensions, is efficient in its use of water and consumption of power, and is of a single-container construction capable of being easily sterilized in the event of contamination.

The example device is configured so as to be secured in a useful position for ease of thawing and removal therefrom when thawing is complete. As the drain plug for a kitchen sink can be easily lost and does not always seal well, one example embodiment of the device may incorporate means for plugging a sink basin in conjunction with securing the device to the sink basin or container.

In the following description, certain specific details are set forth in order to provide a thorough understanding of various example embodiments of the disclosure. However, one skilled in the art will understand that the disclosure may be practiced without these specific details. In other instances, well-known structures associated with manufacturing techniques have not been described in detail to avoid unnecessarily obscuring the descriptions of the example embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one example embodiment” or “an embodiment” means that a particular feature, structure or characteristic described in connection with the embodiment is included in at least one embodiment. Thus, the appearances of the phrases “in one example embodiment” or “in an embodiment” in various places throughout this specification are not necessarily all referring to the same embodiment. Further, the particular features, structures or characteristics may be combined in any suitable manner in one or more example embodiments.

As used in this specification and the appended claims, the singular forms “a,” “an,” and “the” include plural referents unless the content clearly dictates otherwise. The term “or” is generally employed in its sense including “and/or” unless the content clearly dictates otherwise.

As used in the specification and appended claims, the terms “correspond,” “corresponds,” and “corresponding” are intended to describe a ratio of or a similarity between referenced objects. The use of “correspond” or one of its forms should not be construed to mean the exact shape or size. In the drawings, identical reference numbers identify similar elements or acts. The size and relative positions of elements in the drawings are not necessarily drawn to scale.

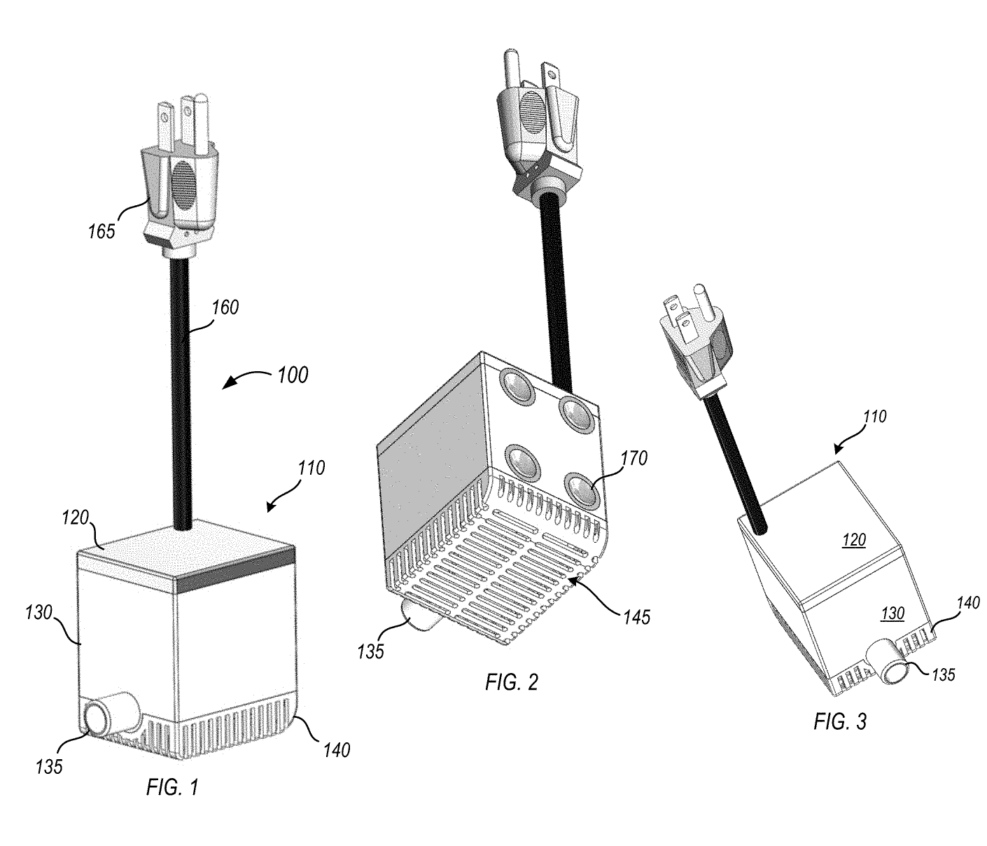

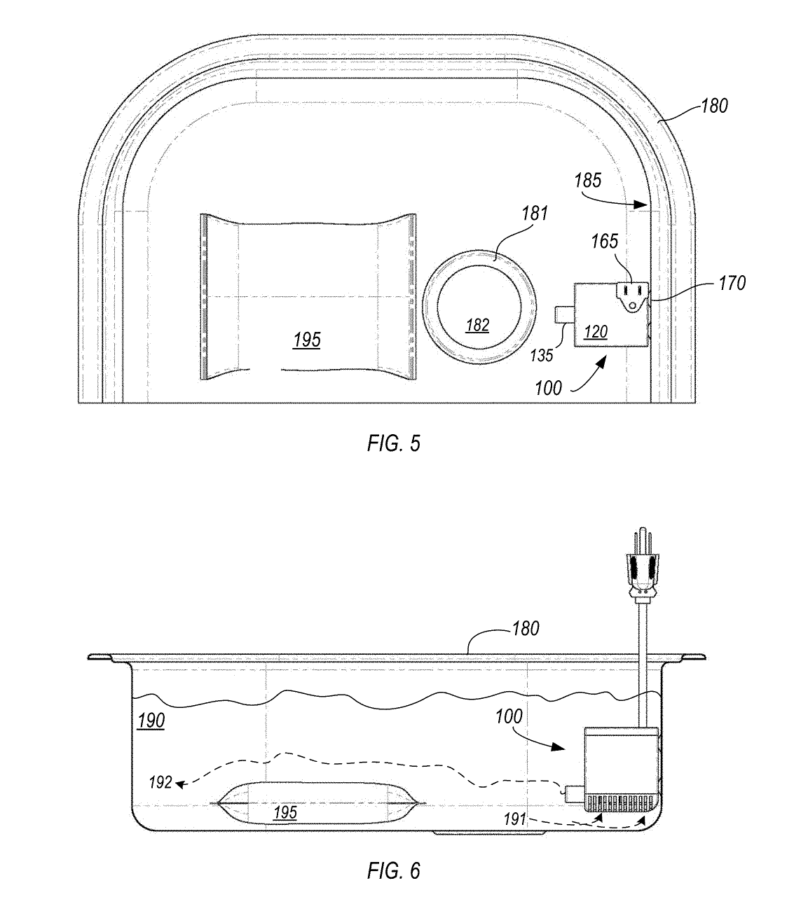

Referring now to FIGS. 1-6, there is shown a device 100 designed to facilitate thawing of one or more frozen food items. Device 100 includes a housing 110. Housing 110 is adapted for immersion in a container 180 (FIGS. 5 and 6) having a fixed amount of water 190 therein along with full immersion of the one or more frozen food items 195 to be thawed in the water 190. Although in this example container 180 is shown as a kitchen (or bathroom) sink, container 180 may be embodied as any plastic, metal, or glass food container having an opening (uncovered) and adapted to be filled with a volume of water, the device 100 secured and immersed therein.

Housing 110 further comprises an upper cover 120 attached to a housing body 130, and a lower cover 140 attached to the housing body 130. Each of the upper cover 120, housing body 130, and lower cover 140 may be composed of an elastomeric water-resistant synthetic material such as a hard plastic, and/or plastics sealed or coated with various epoxies to prevent contact of fluids or moisture with internal electrical components.

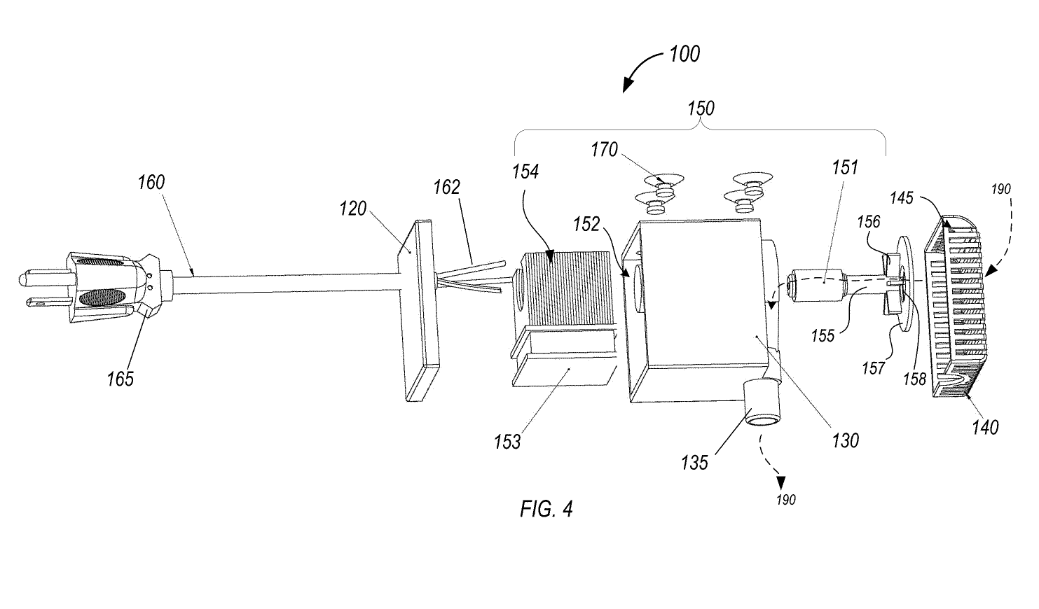

The lower cover 140 includes a plurality of slits 145 in adjacent spaced relation. Slits 145 serve as inlets for the water 190 to be drawn into the pump 150 within the housing body 130, as best shown in FIG. 4. Housing 110 has a securing structure attached thereto for securing the device fixedly in place to a surface 185 of the container 180. In this example embodiment, the securing structure is shown as a plurality of suction cups 170 attached to one of the sides of the housing body 130.

A sealed, waterproof electric submersible pump 150 is provided within the housing body 130. This pump 150 may be a centrifugal-type submersible pump as is known; one example may be a small AC-powered aquaponic or pond pump which can be purchased online or off-the-shelf retail and which generally has a rated flowrate of 100 GPH or less, as a lower flow rate is more than sufficient to facilitate efficient thawing in a container 180 such as a sink. In this example, pump 150 is AC-powered via a cord 160 connected to pump 150 at one end through an aperture in the upper cover 120, the other end of cord 160 terminating in a plug 165 adapted for connection to AC wall power or another AC outlet source. Pump 150 is adapted to agitate water from the container 180 that is drawn in by the pump 150 through the slits 145 of the lower cover 140 into the housing body 130. Device 100 further includes an agitator outlet 135 attached to the housing body 130 for exhausting the water 190 agitated by the pump 150 so as to be circulated at a constant flow rate over the one or more frozen food items 195.

As best shown in FIG. 4, the submersible pump 150 essentially comprises a rotor 151 or impeller that rotates within an electrically insulated and waterproof rotor bore 152 for the rotor 151. The rotor 151 contains a magnet (not shown) which attracts to the metal stator vanes 154 of stator 153. This magnetic attraction permits rotor 151 causes rotor 151 to ‘float” in position. The rotor 151 or impeller is essentially a component of a centrifugal pump, and is driven by a motor to increase the pressure and flow of a fluid such as water 190. The rotor 151 in an example may be made of any metal (e.g., iron, steel, bronze, brass, or aluminum), rubber or plastic. The rotor 151 includes a cylinder 155 and rotor vanes 156 at a bottom thereof that overlay an open inlet called an eye 158 of a rotor shroud 157. The rotor vanes 156 push the water 190 radially.

The rotor 151 transfers energy from the motor to the fluid (water 190) being drawn up through the slits 145 and through the eye 158 (which accepts the incoming water 190). The water 190 is pumped to the agitator outlet 135 by accelerating the water 190 outwards from the center of rotation. The velocity achieved by the rotor 151 or impeller transfers into pressure when the outward movement of the water 190 is confined by the rotor casing 152.

The inventor has discovered through research and experimentation that a modest but constant flow rate of fluid directed over the surface of the food item, coupled with a lower water temperature (a temperature which inhibits growth of bacteria) appears to speed the thawing of food items. As such, the example embodiments envision a flow rate generated by the pump 150 of less than 100 GPH, a preferable example range being a generated flow rate between about 50 to 90 GPH, and contemplate a lower water temperature range, above freezing but less than ambient room temperature to ensure food safety, a preferable example range of cold water temperature (such as cold water from a tap) being between about 35° F. to 42° F.

The cold water temperature range is consistent with governmental guidance which suggests that thawing frozen foods so that the internal temperature of the frozen food remains about 40° F. or less optimizes food safety. This critical range of cold water temperature can be based on the USDA's general guidance on refrigeration, which slows bacterial growth. Namely, bacteria exist everywhere in nature, in the soil, air, water, and the foods we eat. When they have nutrients (food), moisture, and favorable temperatures, they grow rapidly, increasing in numbers to the point where some types of bacteria can cause illness. Bacteria grow most rapidly in the range of temperatures between 40° F. and 140° F., the “Danger Zone,” some doubling in number in as little as 20 minutes. A refrigerator set at 40° F. or below will protect most foods. As such, a thawing range with water circulation according to the devices of the example embodiments between 35° F. to 42° F. or so would minimize the bacteria growth threat, so that a frozen food item's internal temperature during thaw would never exceed 40° F., optimizing food safety.

To explain the method of operation of thawing frozen food in cold water according to the example embodiments, some of guidance for thawing food in cold water without agitation (e.g., still or standing cold water) as specified by the USDA and FDA should be followed. Namely, the food items must be in a leak-proof package or plastic bag which preferably contains no air therein. If the bag leaks, bacteria from the air or surrounding environment could be introduced into the food. Also, bagging meat, chicken, and fish tissue as suggested prevents the absorption of water, which may negatively affect taste and texture of the food item, and/or could result in a watery product.

The bag should be submerged in cold tap water in a temperature range (which can be checked by a user simply with a thermometer) as suggested above. With no agitation, the recommendation is that the water should be changed every 30 minutes so the food item continues to thaw. However, since the inventor's method of thawing, namely, placing the device 100 in the water submerged at a temperature of 35-42° F., and then powering the device 100 to agitate and circulate water over the food items, what usually might take an hour (or less) according to the USDA to thaw small packages of meat, poultry or seafood in standing cold water—about a pound—may be reduced to about 20 minutes or less with the example device 100. Similarly, a 3-to 4-pound package thawing in standing cold water (which the USDA says may take 2 to 3 hours) may be cut in half or more with the device 100.

Water 190 of higher temperature will more quickly impart heat to the frozen items 195 and cause them to thaw more quickly than cold water, though food may be warmed above 40 degrees F. Using the device 100 to circulate water 190 will improve this heat transfer and further reduce time required for thawing, with water 190 of any temperature. By reducing time required to thaw, the device 100 reduces potential exposure time of food items 195 to temperatures in the “Danger Zone”, and thus improves food safety.

Taking into account the above guidance, in operation a frozen food item 195 that has been bagged, preferably in an air-tight fashion to eliminate the potential for bacteria formation on thaw, is placed in container 180, shown as a sink basin in FIGS. 5 and 6. Device 100 is then secured to a surface 185 in container 180; here shown as a sidewall surface. The suction cups 170 hold device 100 secure to the surface 185 of container 180. As container 180 is a sink basin, drain 181 is closed with a suitable plug 182, and container is then filled with a fixed volume of water 190. The plug 165 of device 100 is then connected to an AC source of power (outlet in wall, external source, etc.) to energize pump 150. Intake arrows 191 represent the ingress of water 190 through the inlet slits 145. The ingression of water 190 is agitated within device 100 by pump 150 and outlet 135 then exhausts the water 190 agitated by the pump 150 so as to be circulated (shown by outlet arrow 192) at a constant flow rate over and/or around one or more bagged, frozen food item 195.

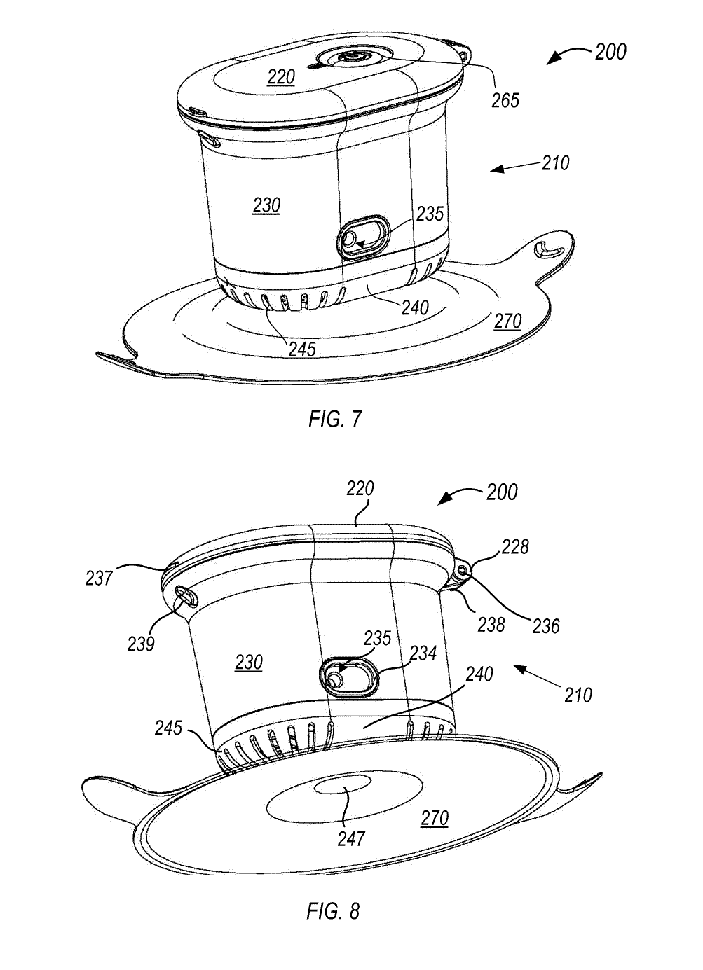

FIGS. 7 through 11 are directed to another example embodiment. In general, device 200 to be described hereafter is similar to device 100 of FIGS. 1 to 6, although it has a slightly different structural makeup as it includes a battery powered DC submersible pump and includes a different securing structure incorporating a dual function.

Referring to FIGS. 7-11, and similar to the previous embodiment, device 200 includes a housing 210 adapted for immersion in a container 180 having a fixed volume of water 190 therein along with full immersion of the one or more frozen food items 195 to be thawed in the water 190. Container 180 may be any of a kitchen (or bathroom) sink, or any of a plastic, metal, or glass food container having an opening (uncovered) and adapted to be filled with a fixed amount of water, the device 200 secured and immersed therein.

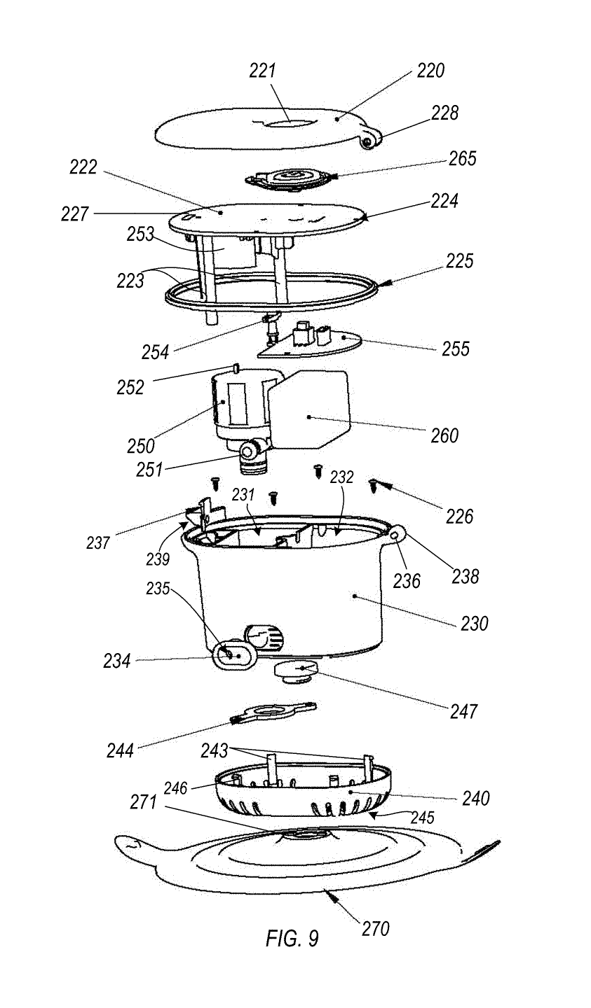

Referring now to FIG. 9, housing 210 includes an upper cover 220 that may be rotatable to be opened by pressing a release 239, which releases a latch 237 (from slot 227) to permit the upper cover 220 to rotate toward an open position via a pivot element (comprised of engaging eyelets 228/238 rotatable about a pivot pin 236). Upper cover 220 may be opened to access a chamber 232 to expose a power jack for recharging a battery 260 therein, or for battery 260 replacement. Housing 210 also includes a hollow housing body 230 and a lower cover 240 attached thereto. Each of the upper cover 220, housing body 230, and lower cover 240 may be composed of an elastomeric water-resistant synthetic material such as a hard plastic, and/or plastics sealed or coated with various epoxies to prevent contact of fluids or moisture with internal electrical components.

A cover plate 222 is sandwiched between the upper cover 220 and a silica gel plate 225, which serves as a gasket between the cover plate 222 and the housing body 230. A series of fasteners 226 (screws) extend through threaded bores 224 in the cover plate 222 connect the cover plate 222 and upper cover 220 to the housing body 230.

An upper portion of the housing body 230 includes the latch 237 and the release 239 which is best shown in FIGS. 6 and 8. The interior of housing body 230 is divided into two chambers 231 and 232. Support beams 223 from the cover plate 222 extend down through these chambers 231, 232 to engage corresponding members 243 extending up from the lower cover 240, thereby sandwiching the housing body 230 therebetween. Latch elements 246 engage recesses (not shown) in the lower part of housing body 230 to secure the lower cover 240 to the housing body 230.

The upper cover 220 includes an opening 221 through which an on/off power button 265 is accessed. The on/off button 265 is electrically connected via a printed circuit board 255 to a DC power supply (the battery 260) which in turn powers a sealed, waterproof submersible DC pump 250 via the PCB 255 and an LGF 254, which is a plastic lens that covers an LED that alights underneath the on/off button 265 when the device 200 is energized on. Battery 260 may be embodied as any of alkaline, lead-acid, coin and aluminum-ion non-chargeable batteries and the like, or rechargeable batteries such as nickel cadmium (NiCd), nickel metal hydride (NiMH), and lithium ion cells. In an example, PCB 255 may include means to regulate battery 260 charging. The PCB 255 and battery 260 are thus contained in chamber 232; the pump 250 is contained within chamber 231 and is surrounded partly by a sheath 253 extending down from cover plate 222 to retain the pump 250 therein. An axle 252 helps to secure the pump 250 to the underside of cover plate 222 within sheath 253.

The lower cover 240 includes a plurality of slits 245 in adjacent spaced relation, which as before serve as inlets for the water 190 to be drawn into the pump 250 within the housing body 230. Unlike the previous embodiment, the securing structure attached to housing 210 is different and serves multiple purposes. A single broad and wide suction disk 270 is attached to the lower cover 240 via a bearing gasket 244 secured within the lower interior surface of lower cover 240, and a plug 247. The plug 247 extends through a central aperture 271 in disc 270 and through a hole in the bottom of lower cover 240, and is captured by gasket 244 on the interior surface of the lower cover 240 for securing the device 200 to the disc 270. Suction disc 270 contacts a surface 185 of container 180 (such as sink bottom surface) and provides two functions: namely disc 270 serves as a plug for the drain 181 of container 180 so that water 190 may be added to a fixed level, and also due to its suction to surface 185 serves to fixedly secure the device 200 in container 180.

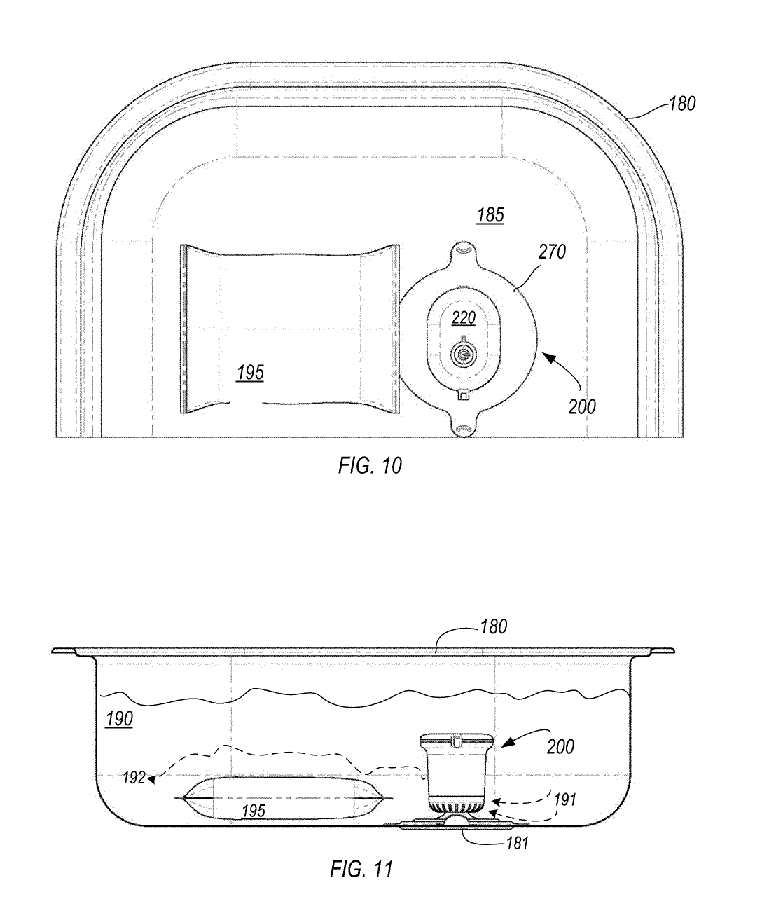

Pump 250 may be a centrifugal-type brushless DC submersible pump as is known; one example may be a small 6V or 12V battery powered DC submersible water pump which can be purchased online or off-the-shelf retail. Alternatively, pump 250 may be powered with a sealed, brushed DC motor. In an example, pump 250 has a rated flowrate of 100 GPH or less, as a lower flow rate is more than sufficient to facilitate thawing in a container 180 such as a sink. Pump 250 agitates the water 190 from the container 180 that is drawn in through the slits 245 of the lower cover 240 into the housing body 230, shown by the intake arrows 191 in FIGS. 10 and 11. The agitated water 190 is sent through a pump outlet 251 that is aligned with an agitator outlet 235 that is recessed within a bracket 234 provided along an outer side surface of the housing body 230, as shown in FIG. 9. The agitator outlet 235 exhausts the water 190 agitated by the pump 250 so as to be circulated at a constant flow rate (as shown by outlet arrow 192) over and/or around the one or more frozen food items 195.

The above two example embodiments thus describe devices 100/200 that accelerate and/or facilitate thawing of frozen food items immersed in a fixed amount of water within a sink basin or other metal, plastic, or glass food container. With the device 100 or 200 immersed in water 190 of a fixed level or amount within a container 180, a submersible pump 150/250 draws the water 190 through the device 100/200 and circulates it through the container 180, efficiently using the water 190 while providing constant circulation over the frozen food items 195. It is envisioned that use of the example devices 100/200 may significantly reduce the time required to thaw frozen foods. As the devices 100/200 are used in low-temperature water to optimize food safety (approximately 35° F. to 42° F.), the frozen food items may be thawed to a chilled condition while avoiding higher temperatures (such as those typically used in a microwave to defrost) that encourage bacteria growth.

The example devices 100/200 are also simple to secure in place within the container for operation, and due to their small size and simple construction may be easily cleaned and sterilized if contamination of the device 100 or 200 should occur.

Additionally, a suction disc 270 may be employed with a dual purpose of securing the device in the container (such as a sink, commonly available in food preparation areas and thus easily filled, cleaned, and drained) while also plugging the drain of the sink to permit filling it with the fixed amount of water to immerse the frozen food items and device therein. Further, providing inlets (slits 145/245) in the lower cover 140/240 helps assure that water 190 is always available to the submersible pump 150/250 even where the water level may be low.

However, a series of small suction cups 170 or a broad suction disc 270 are merely two example securing structure configurations; others are contemplated as to be described hereafter. Additionally, in lieu of being powered by a battery 260, the DC centrifugal pump of device 200 may be connected via a cord to an external source of DC power.

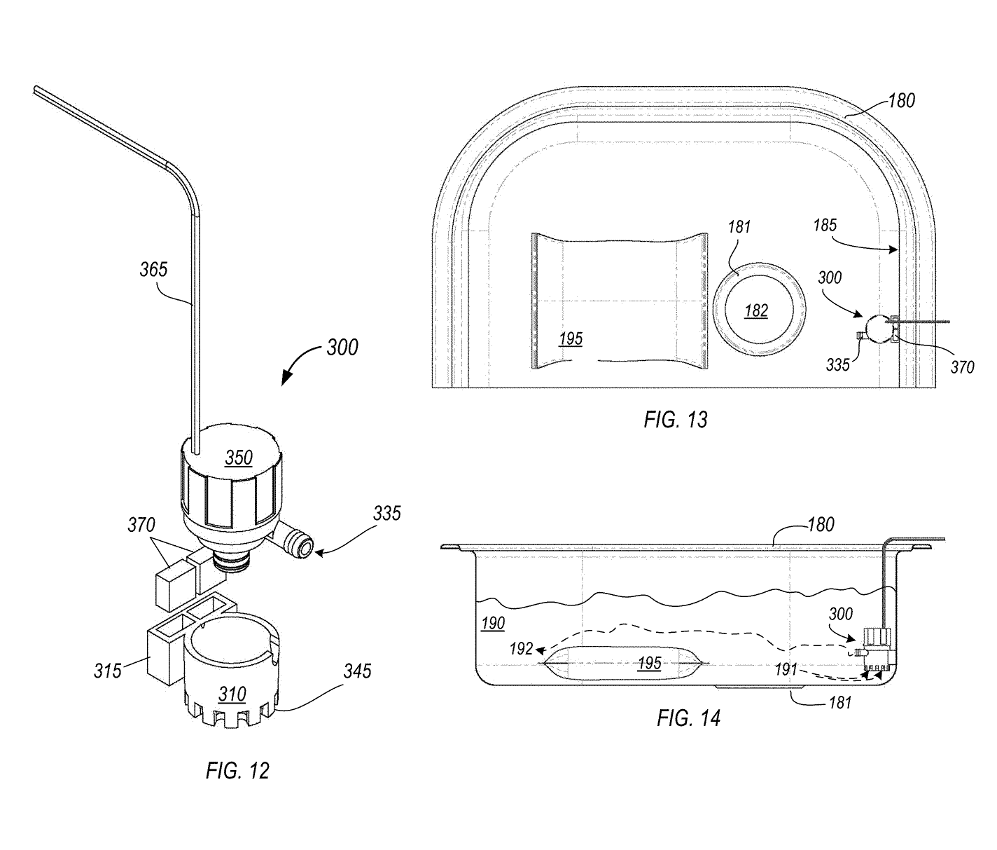

FIG. 12 shows a partial exploded parts view of a device to facilitate thawing of frozen food items, according to another example embodiment; FIG. 13 illustrates a top plan view of the device of FIG. 12 immersed with a sealed food item in a container; and FIG. 14 shows a rear plan view of the container in FIG. 13 with food item and device therein. Referring to FIGS. 12-14, device 300 is similar to devices 100 and 200 in regards to the core components and mode of operation to agitate water 190 so as to create a constant flow rate over a food item 195 submerged in a volume of water 190 within a container 180. As such, only key differences are discussed in detail for sake of brevity.

Namely, FIG. 12 illustrates a device 300 that is not battery-powered. But instead has a sealed, waterproof DC submersible water pump 350 that is connected, via cord 365 to an external source of DC power; thus a corded embodiment of a DC powered device 300. Additionally, the housing structure and securing structure differ as compared to that shown in FIGS. 1-6 or FIGS. 7-11. Pump 350 rests in an open-top housing 310 which includes a plurality of slits 345 at a lower end for water 190 egress. Operation is the same as previously described, in that water 190 sucked up through slits 345 is agitated by pump 350 and exhausted via outlet 335 so as to flow at a constant rate over food item 195. Further, housing 310 include a double-chambered structure 342 integral therewith which is adapted to receive a pair of magnets 370 therein. Thus, in the event the container 180 is formed of a material having magnetic properties, the magnets 370 have such a pull force strength so as to attract the surface 185 of container 180 through the intervening material of the double-chambered structure 342.

In one example, magnets 370 may be comprised of Ferrite. In another, magnets may be Neodymium iron boron magnets (NdFeB, also known as Neo, NIB, rare earth, or super magnets). This magnet is the strongest commercial magnet material currently produced. As magnets typically have poor resistance to corrosion, the magnets would be subject to proper pre-treatment processes and/or application of a plating such as a multi-layer nickel-copper-nickel plating. Alternatively, magnets 370 may be Samarium cobalt (SmCo) magnets, another type of rare earth magnets, which typically are regarded as offering the best value when comparing performance and size in high temperature or adverse environments. In yet another example, magnets 370 may be Alnico magnets, which are largely comprised of aluminum (Al), nickel (Ni), cobalt (Co), aluminum and other trace amounts of elements such as copper (Cu) and titanium (Ti) to tailor the alloy's magnetic and mechanical properties.

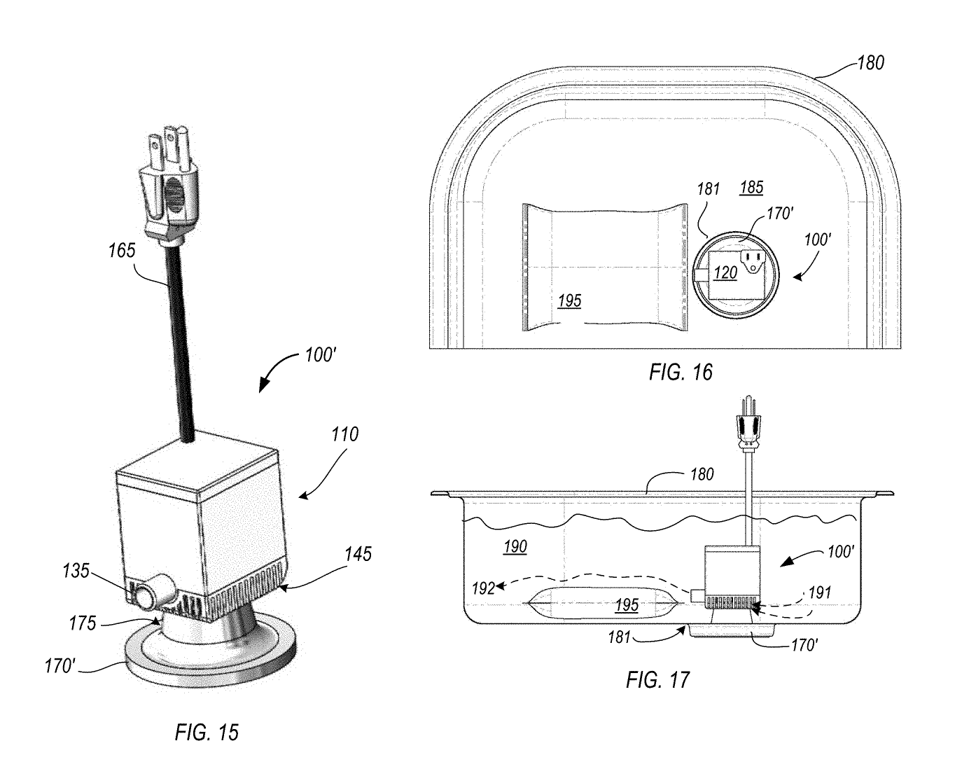

FIG. 15 shows a perspective view of a device to facilitate thawing of frozen food items, according to another example embodiment; FIG. 16 is a top plan view of the device of FIG. 15 immersed with a sealed food item in a container; and FIG. 17 is a rear plan view of the container with food item and device therein. Referring to FIGS. 15-17, there is shown a device 100′ identical to the corded device with AC powered pump 150 shown in FIGS. 1-6. Here, and in lieu of employing small suction cups 170 or a broad suction disc 270 as the securing structure, the securing structure for device 100 is an integral, circular drain plug element 170′ attached to an underside of the housing 110 of device 100′ via a columnar extension or stalk 172, such that the slits 145 remain above the bottom surface 185 of container 180 to enable the ingress of water 190 into housing 110 via the suction of AC pump 150. When installed, the drain plug element 170′ plugs a drain 181 in the container 180 while also securing device 100′ in the container 180.

The example embodiments having been described, it is apparent that such have many varied applications. In an example, the device 100 with the AC submersible pump 150 (see FIG. 2) could have a single suction cup such as is shown for device 200 that could cover the drain, and the device 200 with the DC pump 250 could have one or more smaller suction cups to secure device to a sink surface such as a sidewall. Also, the example embodiments may be applicable but not limited to connection to various devices, structures and articles.

In a further alternative embodiment, the device 100 or 200 may include timing and environmental monitoring means to indicate data such as operating time, water temperature, change in water temperature, temperature of the one or more items being thawed, and the like. As an example, devices 100/200 may incorporate timing and signaling means so that, once activated, the devices 100/200 will operate for an established period of time, and then signal the user visually and/or audibly that a thaw cycle is complete. A limited cycle serves to prevent excess operation and depletion of power. Similarly, where an automated thaw cycle is employed, the devices 100/200 may include water temperature monitoring devices or sensors, signaling the user as water temperature increases, either indicating thawing is completed or that the water temperature has risen to undesirable level.

In yet another alternative example, devices 100/200 could be configured to implement an optional heating function to heat the water it circulates, or could be configured with an optional cooling function that may be implemented to maintain the fixed amount of water at a desired temperature or within a desired range; e.g., to keep water temperature below 42° F., using Peltier thermoelectric or similar devices. The above functions may be effected in an example by way of electronic communication means, so that instructions (such as initiating a timed operating cycle, and/or transmitting its data for access by an operator or automated remote controller) can be remotely sent to the device.

Additionally, devices 100/200 may also be configured to provide thermostatic temperature control, or to provide temperature indication on the device itself or wireles sly via a sensor communicating temperature information to a user via a smartphone app. Given inputs that include the weight and thickness of the food item and the volume of water used, such an app could estimate when thaw of the food item is complete, based on a detected rise in water temperature.

In another variant, the slits that form the inlet to the pump may include filtering devices or materials, or may include a means to implement centrifugal separation of debris from water being drawn in. In yet another variant, the various structural components of devices 100/200 may include anti-microbial materials, coatings, and the like.

In yet a further variant as applied to the AC-powered embodiment of device 100, water may be routed through the AC coils of the rotor to inhibit growth of water-borne microbes. In yet a further variant as applied to the DC-powered embodiment of device 200, insulated, high voltage DC electrodes may be provided around the water path through the inlet in the bottom to inhibit growth of water-borne microbes. In yet a further variant, a Venturi could be fitted to the agitator outlets to draw in ozone-dense air in order to reduce water-borne microbes.

The present invention, in its various embodiments, configurations, and aspects, includes components, systems and/or apparatuses substantially as depicted and described herein, including various embodiments, sub-combinations, and subsets thereof. Those of skill in the art will understand how to make and use the present invention after understanding the present disclosure. The present invention, in its various embodiments, configurations, and aspects, includes providing devices in the absence of items not depicted and/or described herein or in various embodiments, configurations, or aspects hereof, including in the absence of such items as may have been used in previous devices, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures to those claimed, whether or not such alternate, interchangeable and/or equivalent structures disclosed herein, and without intending to publicly dedicate any patentable subject matter.

I claim:

1. A device to facilitate thawing of one or more frozen food items, comprising:
a housing adapted for immersion in a container having a fixed amount of water therein along with full immersion of the one or more frozen food items to be thawed in the water, the housing including a plurality of slits in adjacent spaced relation to one another and serving as inlets for the water to be drawn into the housing,
a securing structure attached to the housing for securing the device fixedly in place to a surface of the container,
a sealed, waterproof submersible pump provided in the housing, the pump adapted to agitate water from the container that is drawn in by the pump through the slits, and
an agitator outlet attached to the housing for exhausting the water agitated by the pump into the container so as to be circulated at a constant flow rate over the one or more frozen food items.

2. The device of claim 1, wherein the pump circulates the water of the one or more frozen food items at a constant flow rate.

3. The device of claim 1, wherein the securing structure comprises one or more suction cups attached to the housing.

4. The device of claim 1, wherein the securing structure is a suction disc attached to an underside of the housing, the suction disc adapted to be placed over a drain of a container to secure the device to the container while facilitating filling the container with a fixed amount of water.

5. The device of claim 1, wherein the securing structure comprises a drain plug that is integral with a stalk that is connected to the housing so that the slits remain above a bottom surface of the container.

6. The device of claim 1, wherein
the container has magnetic properties, and
the securing structure comprises one or more magnets attached to the housing for engaging a magnetized surface of the container.

7. The device of claim 1, wherein the submersible pump is AC-powered from an external source via a plug with a power cord connected to the pump.

8. The device of claim 1, wherein the submersible pump is DC-powered via a battery contained in the housing body and connected to the pump.

9. The device of claim 8, wherein
an upper external surface of the housing includes an on/off power button thereon, and
the housing interior includes a printed circuit board and the battery, the printed circuit board in electrical communication with the on/off button and the battery to power the DC pump.

10. The device of claim 1, wherein the submersible pump is DC-powered from an external source via a plug with a power cord connected to the pump.

11. The device of claim 1, wherein the container is any of a kitchen sink, bathroom sink, and a single plastic, metal, or glass food container adapted to be filled with a fixed amount of water, the device immersed therein.

12. The device of claim 1, wherein the housing further comprises a hollow housing body which contains the pump therein, an upper cover attached to the housing body, and a lower cover attached to the housing body, the lower cover including the plurality of slits therein.

13. The device of claim 1, wherein the submersible pump circulates water at 100 GPH or less.

14. A device to facilitate thawing of one or more frozen food items, comprising:
a housing adapted for immersion in a container having a fixed amount of water therein along with immersion of the one or more frozen food items to be thawed in the water, the housing including a plurality of slits therein for ingress of the water into the housing,
one or more suctions cups attached to an external surface of the housing body for securing the device fixedly in place to a surface of the container,
a sealed, waterproof submersible pump provided in the housing body and adapted to agitate water from the container that is drawn up through the slits, and
an agitator outlet in the housing for exhausting the water agitated by the pump into the container so as to be circulated at a constant flow rate over the one or more frozen food items.

15. The device of claim 14, wherein the submersible pump is a corded AC pump powered from an external source via a plug with a power cord connected to the pump.

16. The device of claim 14, wherein the submersible pump is DC pump powered via a battery contained in the housing body and connected to the pump or a corded AC pump powered from an external source via a plug with a power cord connected to the pump.

17. A device to facilitate thawing of one or more frozen food items, comprising:
a housing adapted for immersion in a container having a fixed amount of water therein along with immersion of the one or more frozen food items to be thawed in the water, a lower portion of the housing including a plurality of slits in adjacent spaced relation,
a securing structure attached to the housing, the securing structure adapted to fix the device in place to a surface of the container and simultaneously to plug a drain of the container to permit filling with water,
a sealed, waterproof submersible pump provided in the housing to agitate water from the container that is drawn through the slits, and
an agitator outlet in the housing body for exhausting the water agitated by the pump into the container so as to be circulated at a constant flow rate over the one or more frozen food items.

18. The device of claim 17, wherein the securing structure comprises a suction disc attached to an underside of the housing, the suction disc adapted to be placed over the drain of the container as a plug to secure the device to the container while facilitating filling the container with the fixed amount of water.

19. The device of claim 17, wherein the securing structure comprises a drain plug that is integral with a stalk that is connected to the housing so that the slits remain above a bottom surface of the container.

20. The device of claim 17, wherein the housing further includes:
a hollow housing body, an upper cover pivotable at one end and attached to the housing body to provide access to the interior of the housing body, the upper cover includes an on/off power button, the housing body further including a printed circuit board and a battery, the printed circuit board in electrical communication with the on/off button and battery to power the DC pump, and
a lower cover attached to the housing body, the lower cover including the slits therein, the suction disc attached to an underside of the lower cover.
